(19) United States
(12) Patent Application Publication
(10) Pub. No.: US 2008/0117624 A1
(43) Pub. Date: May 22, 2008

(54) Lighted apparel and footwear

(76) Inventor: Borislav Kirkov, Brooklyn, NY (US)

Correspondence Address: ROBERT T. MALDONADO;Cooper & Dunham LLP, 1185 Avenue of the Americas, New York, NY, 10036, US

(21) Appl. No.: 11/603,655

(22) Filed: Nov. 22, 2006

(51) Int. Cl. F21V 21/108; F21V 21/08; H05B 33/00

(52) U.S. Cl. 362/108; 362/103; 362/84

(57) ABSTRACT

A lighted apparatus for use in apparel and footwear is described. The lighted apparatus includes an exterior channel formed in the outer perimeter of the sole, one or more light sources mounted in the exterior channel, a protective covering surrounding the light source, one or more switches coupled to the light source, and one or more power sources operatively coupled to the one or more switches and the one or more light sources. In apparel, the one or more continuous light sources are removably attached to the garment.

### FIELD OF THE INVENTION

The present disclosure relates generally to the field of apparel and footwear, and more particularly, to apparel and footwear containing a lighted assembly that can be controlled by a wearer to increase the visibility of the wearer.

### BACKGROUND OF THE INVENTION

Individuals such as bicyclists, joggers or pedestrians that are outdoors in the evening or in inclement weather, sharing the road with automobiles may not be visible to drivers. Often, these individuals wear apparel and/or footwear that contain reflective elements so that drivers may notice them. However, these reflective elements are not ideal in poorly lit areas as they require light to function appropriately.

Recently, individuals have worn apparel and/or footwear equipped with lighted assemblies for safety and/or aesthetic reasons. Such known assemblies generally use light emitting diodes (“LEDs”) and other lighting means spaced at multiple locations around the sole of the shoe 1 or apparel. However, LEDs and other lighting means may not emit much light when spaced at various intervals and the light that is emitted may be concentrated in a single area. This may cause a problem if one or more of the LEDs were to burn out.

Moreover, these lighted assemblies employ various switching techniques causing the lighting means to turn on and off and/or intermittently flash. One typical technique involves a switch that responds to an individual's movement. For example, the lighting means may be activated in footwear each time an individual's foot makes contact with the ground and remains on or intermittently flashes for a limited duration of time. However, these techniques do not provide an individual with control over the duration of time that the lighted means will remain on or off. Accordingly, there is a need for providing a different type of lighted apparel and footwear as an alternative to typical apparel and footwear equipped with lighted assemblies.

### SUMMARY OF THE INVENTION

A lighted apparatus for use in footwear including an upper portion and an opaque sole attached to the upper portion, includes, an exterior channel formed in the outer perimeter of the sole, one or more light sources mounted in the exterior channel, a protective covering surrounding the light source, one or more switches coupled to the light source, and a power source operatively coupled to the one or more switches and to the light source through one or more holes in the sole, wherein the power source is located in a cavity formed in the sole and the cavity is connected to the one or more holes.

A lighted apparatus for use in apparel, includes, one or more continuous light sources removably attached to a garment in one or more areas, a protective covering surrounding the light source, one or more switches detachably coupled to the light source, and one or more power sources operatively and detachably coupled to the one or more switches and to the one or more light sources on the garment.

### BRIEF DESCRIPTION OF THE DRAWINGS

The features of the present application can be more readily understood from the following detailed description with reference to the accompanying drawings wherein:

FIG. 1 depicts a side view of lighted footwear, according to one embodiment of the present disclosure;

FIG. 2A is a cross-sectional view illustrating a lighted apparatus for footwear, taken along line A-A in FIG. 1, with one continuous light source, according to one embodiment of the present disclosure;

FIG. 2B is a cross-sectional view illustrating a lighted apparatus for footwear, taken along line A-A in FIG. 1, with two continuous light sources, according to another embodiment of the present disclosure;

FIG. 3 is a cross-sectional view illustrating a lighted apparatus for footwear, taken along line B-B in FIG. 1, according to one embodiment of the present disclosure;

FIG. 4A is a front view of a lighted jacket, according to one embodiment of the present disclosure;

FIG. 4B is a back view of a lighted jacket, according to one embodiment of the present disclosure;

FIG. 5A is a plan view of a light source encased in protective coating and sewn to an attachment strip, according to one embodiment of the present disclosure; and

FIG. 5B is a cross-sectional view of a light source sewn to an attachment strip, taken along line C-C in FIG. 5A, according to one embodiment of the present disclosure.

### DETAILED DESCRIPTION OF THE PREFERRED EMBODIMENTS

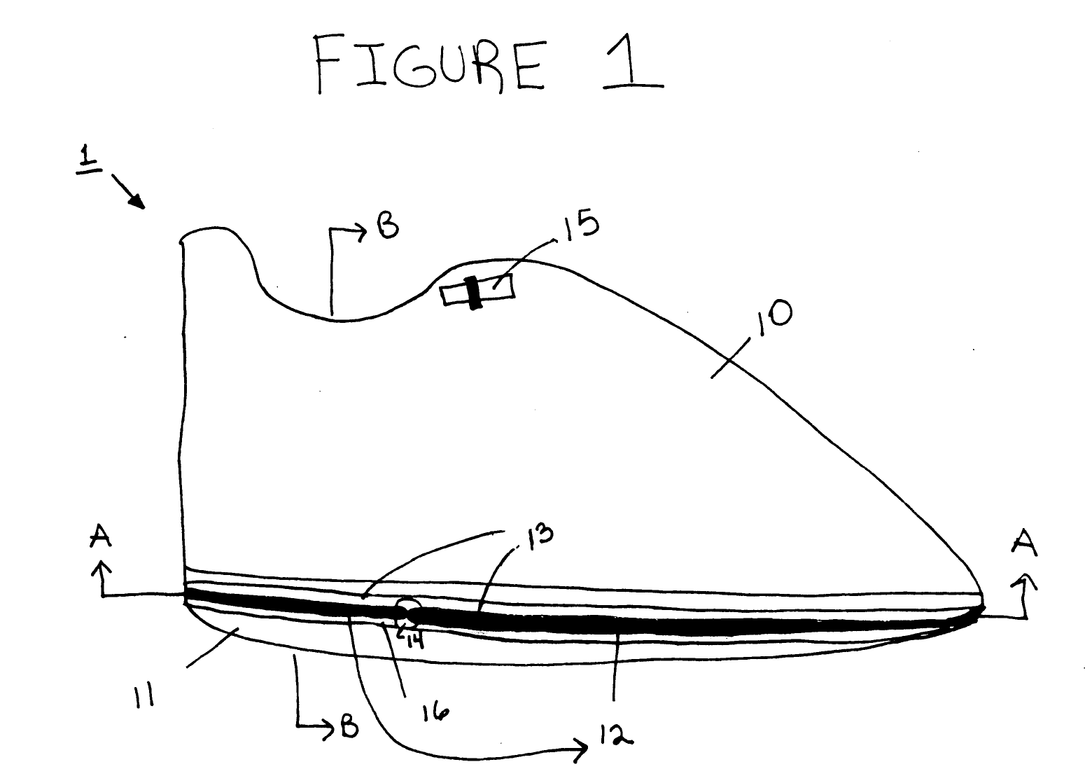

The present invention provides tools for a lighted apparatus for footwear and apparel. FIG. 1 depicts an example of lighted footwear, according to one embodiment of the present disclosure. While sneakers are depicted, it should be understood that any type of footwear may incorporate the present invention, such as men's/women's/children's dress shoes, casual shoes, boots, slippers, etc. The shoe 1 depicted in FIG. 1 includes an upper portion 10, a sole 11 attached to the underside of the upper portion 10, an exterior channel 16 continuously formed along the perimeter of the sole 11, one or more light sources 12 mounted in the exterior channel 16, a protective covering 13 surrounding the one or more light sources 12, and a switch 15 incorporated into the upper portion 10 of the shoe 1. The upper portion 10 may be made out of a soft, thin flexible material, such as leather, cloth, man-made synthetic materials, or any combination thereof. The sole 11 may be opaque and molded out of a resilient, shock absorbing foamed material, such as polyurethane or ethylene vinyl acetate. An exterior channel 16 may be formed in the sole 11 of the shoe 1, having a diameter of, for example, 4 mm. One or more light sources 12 such as electroluminescent wire (“el wire”), neon lighting, or other continuous lighting, may be externally mounted into the exterior channel 16 around the outer perimeter of the sole 11 and provides uniform lighting around the shoe 1. For example, the light source 12 may be a high bright neon el wire that has a diameter of 2.5 mm. The one or more light sources 12 may be protected with a protective covering 13 such as waterproof transparent polyvinyl chloride (“PVC”) or any similar material which may be applied after the light source 12 is mounted in the exterior channel 16. For example, the protective covering 13 may be a 4 mm layer of PVC. According to an embodiment, the protective covering 13 may be disposed around the one or more light sources 12 so that the exterior channel 16 is entirely covered.

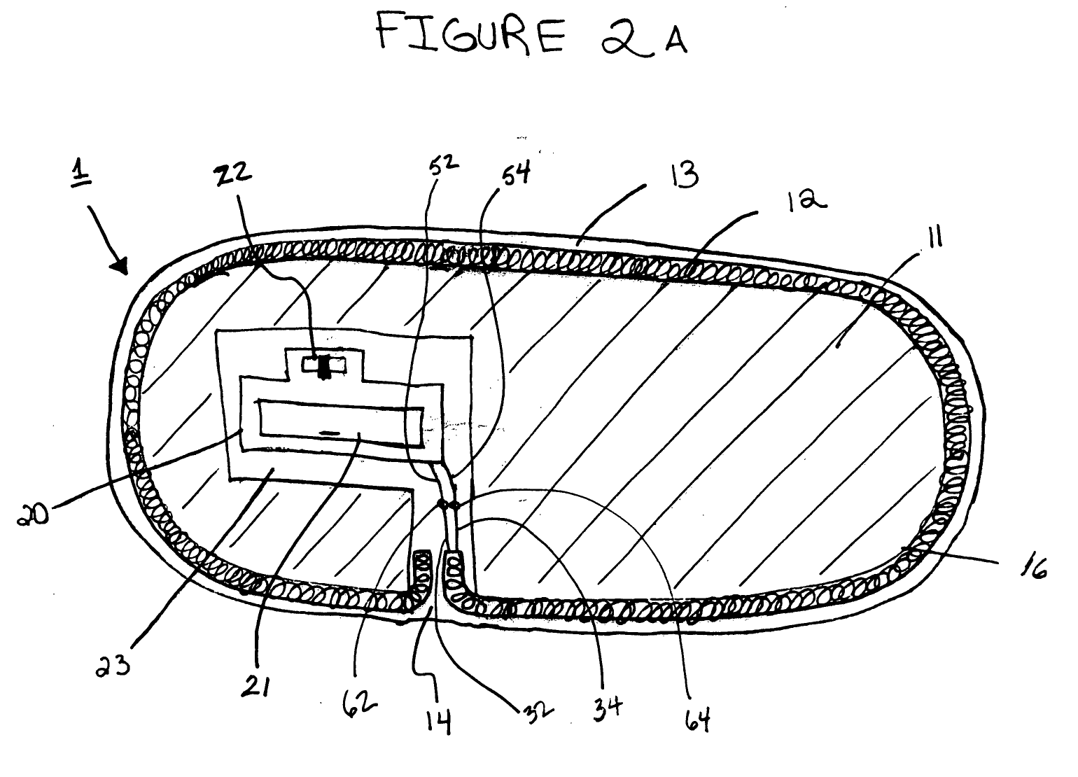

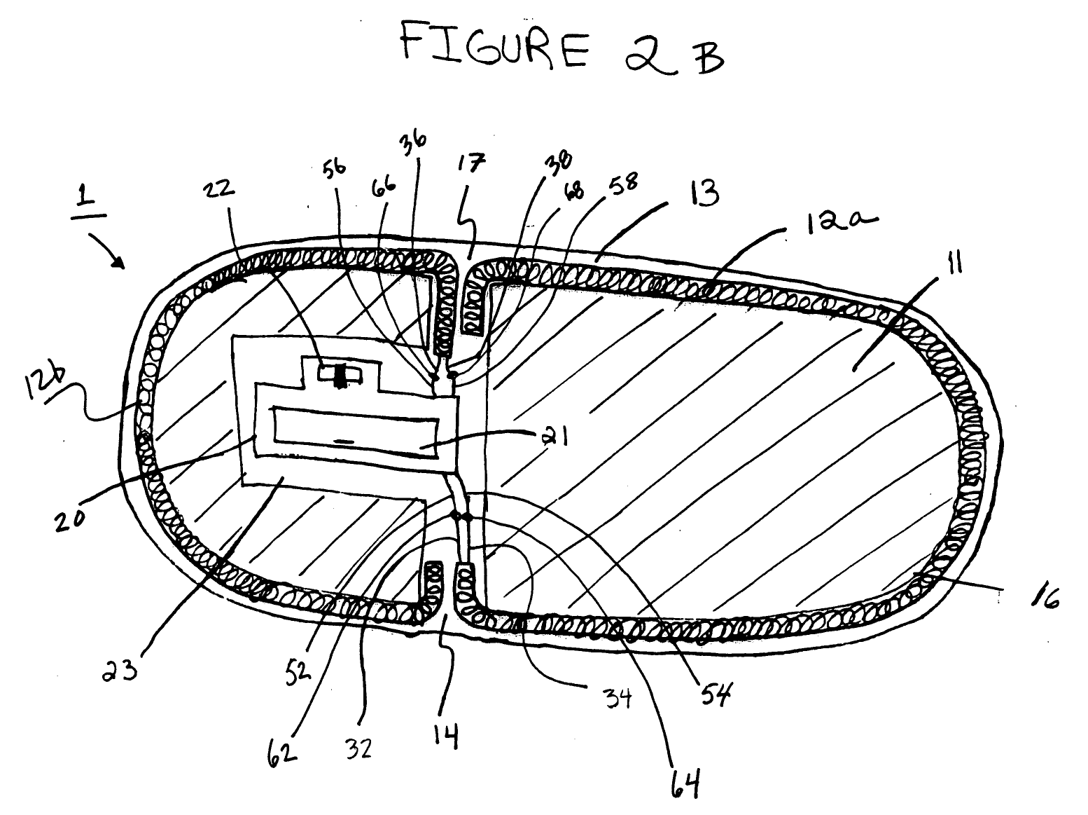

The sole 11 includes one or more holes 14 whereby the one or more light sources 12 may be coupled to one or more switches 15, 22 located in the upper portion 10 of the shoe 1 and/or in a cavity in the sole 11, respectively, and a power source 21, as further explained in accordance with FIGS. 2A and 2B. The switches 15, 22 provide a means for a wearer to turn the one or more light sources 12 on/off or set to a flashing mode.

FIG. 2A is a cross sectional view illustrating a lighted apparatus for footwear, taken along line A-A in FIG. 1, according to one embodiment of the present disclosure. In addition to the exterior channel 16, one or more light sources 12, and protective covering 13 described above, the sole 11 includes a single hole 14 which leads to a cavity 23 formed therein. The cavity 23 extends from a central interior portion of the sole 11 to the hole 14 to provide a continuous path from the exterior of the shoe 1 to the interior of the sole 11 thereby enabling the exteriorly mounted light sources 12 to be connected to the interiorly disposed power housing 20 without visible wires. According to an embodiment, the cavity 23 can be located in any area in the interior portion of the sole 11 of the shoe 1, such as the center.

A power source 21 and a switch 22 may be contained in a power housing 20 which is disposed in the cavity 23. According to an embodiment of the present disclosure, the cavity 23 is a cut-out in the sole 11 which is concealed into the sole 11 and does not protrude. The power housing 20 is contained in the cavity 23 and may include the power source 21. According to one embodiment, the power housing 20 may also include a switch 22. The power source 21 may be a compact battery with sufficient strength to power the one or more light sources 12, for example, one AAA battery. The switch 22 is one that is commonly known in the art, such as, a manual slide-switch, push button switch, or toggle switch, allowing the user to choose between different modes. For example, the switch 22 may be used to turn the light source 12 either on/off or to a flashing mode. In a preferred embodiment, the lighted apparatus includes one hole 14; however, it should be understood from the present disclosure that multiple holes 14, 17 may be provided, as illustrated in FIG. 2B.

The hole 14 allows the switch 22 and a power source 21 to be coupled to the one or more light sources 12 mounted in the exterior channel 16 formed in the sole 11. For example, the light source 12 may be a continuous tube of el tube neon lighting with two ends: one end which is a closed end, and an opposite end which has two wires 32, 34 extending therefrom. The light source 12 is powered through these wires 32, 34, which can be detachably coupled to the wires 52, 54 from the power housing 20. The wires 52, 54 from the power housing 20 are connected to the switch 22 and the power source 21 inside the power housing 20 to form a continuous circuit (not shown). The detachable connections 62, 64 may be provided by alligator clips, for example, or other means well-known to one of ordinary skill in the art. According to another embodiment, a second switch 15 may also be provided. The switch 15 may be connected to the power housing 23 through wires embedded in the upper portion 10 of the shoe 1 (not shown) or may communicate with the power housing 23 through a wireless communication method well known to one of ordinary skill in the art.

FIG. 2B illustrates a lighted apparatus for a shoe 1, taken along line A-A in FIG. 1, according to another embodiment of the present disclosure, wherein two holes 14, 17 are provided in the sole for enabling the one or more light sources 12 to be connected to the interior power housing 20. The two holes 14, 17 may be provided on opposite sides of the sole 11. When configured in this manner, two light sources 12a, 12b may be provided, with one light source 12a being disposed along the perimeter of the front section of the shoe 1, for example, and the other light source 12b being disposed along the perimeter of the rear section of the shoe 1. The closed end of the light source 12a is shown as entering the sole 11 through hole 17, whereas the opposite end of the light source 12a, which has wires 32, 34 extending therefrom, enters the sole 11 through the opposite hole 14. Similarly, the closed end of the light source 12b is shown as entering the sole 11 through hole 14, whereas the opposite end of the light source 12b, which has wires 36, 38 extending therefrom, enters the sole 11 through the opposite hole 17. Although the ends of the light sources 12a, 12b are shown entering the sole 11 in this manner, other arrangements are possible, such as having both closed ends enter the same hole, etc. The wires 32, 34 of the light source 12a are shown connected to the wires 52, 54 of the power housing 20, through detachable connections 62, 64 as described above in connection with FIG. 2A. In addition, the wires 36, 38 of the light source 12b are shown connected to the wires 56, 58 of the power housing 20, through detachable connections 66, 68. According to these connections, the two light sources 12a, 12b may be controlled by a single power source 21. Alternatively, separate power sources may be provided in one or more cavities 23 for each light source 12a, 12b, so as to enable each light source 12a, 12b to be turned on and off independently, or to enable one to provide continuous illumination while the other provides flashing illumination (not shown). The two light sources 12a, 12b may be different colors.

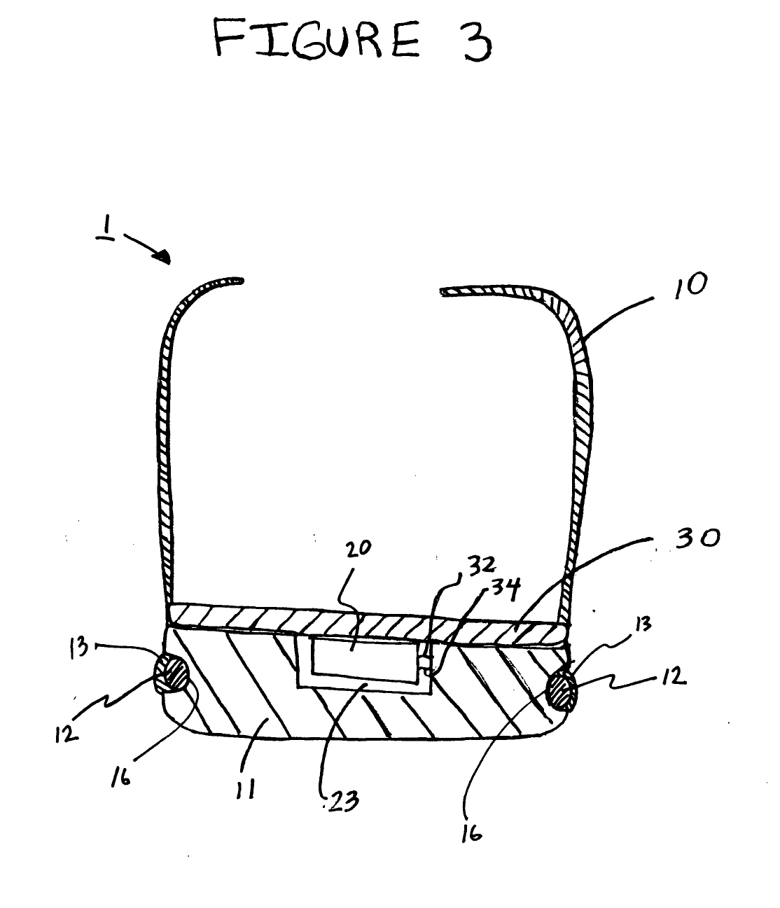

FIG. 3 is a cross-sectional view illustrating a lighted apparatus for footwear, taken along line B-B in FIG. 1, according to one embodiment of the present disclosure. A removable insole 30 is provided inside the shoe 1 to allow a user to comfortably wear the shoe 1 while concealing the power housing 20 in the cavity 23. To access the switch 22, the user removes the insole 30, and then replaces the insole 30 before the shoe 1 is worn.

According to an embodiment of the present disclosure, the wires 32, 34 from the one or more light sources 12 and the power housing 20, including the power source 21 and switch 22 can be disconnected and each article removed so as to enable a user to wash the shoes or to change the light source 12 or the power source 21. For example, the front portion of the shoe 1 separated by the one or more holes 14 may use a different color for the light source 12 from the back portion of the shoe. The switch 15, 22 may include an additional mode allowing for the user to turn one color on/off and/or make one color flash or remain continuously illuminated.

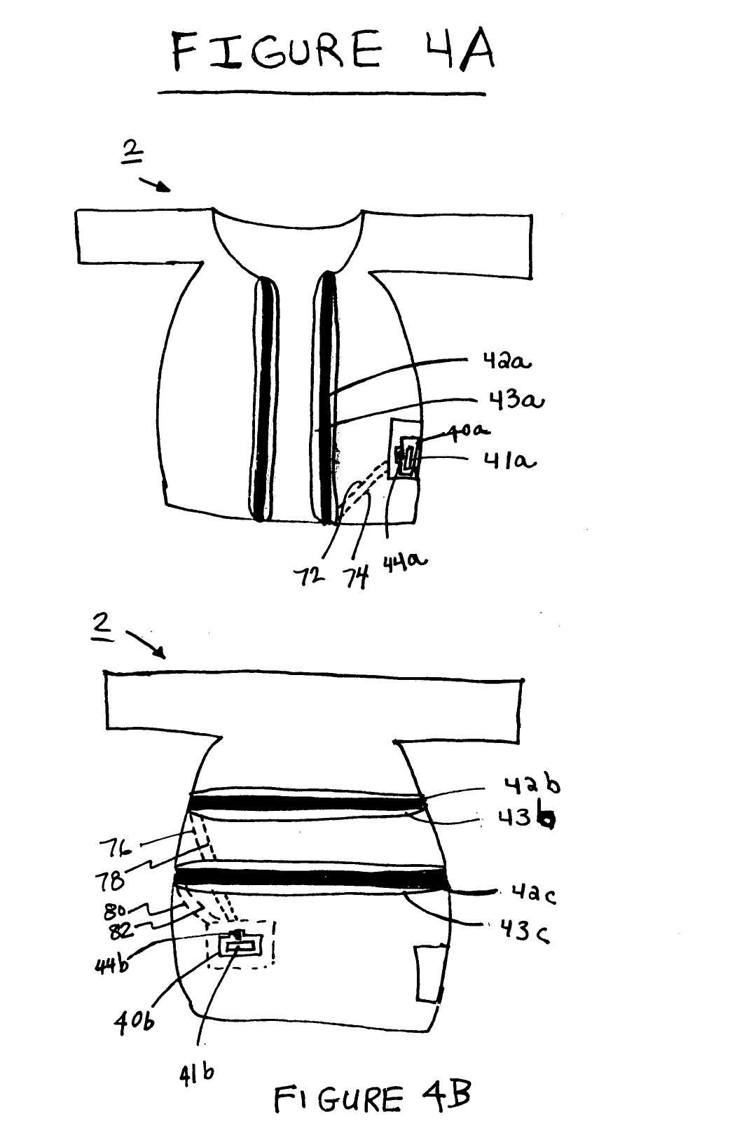

FIG. 4 depicts an example of lighted apparel, according to one embodiment of the present disclosure. While a jacket 2 is depicted, it should be understood that any type of apparel may incorporate the present invention, such as men's/women's/children's pants, shirts, vests, skirts, socks, etc. The jacket 2 depicted in FIG. 4 includes one or more light sources 42a, 42b, 42c, encased in a protective covering 43a, 43b, 43c, one or more power sources 41a, 41b each in a power housing 40a, 40b and one or more switches 44a, 44b. The one or more light sources 42a, 42b, 42c, such as el-wires, are removably attached to the jacket 2 in one or more areas. For example, they may be located along the left and right sides along the zipper on the front of the jacket 2, and vertically and/or horizontally along the back of the jacket 2. The one or more light sources 42a, 42b, 42c may be encased in a protective covering 43a, 43b, 43c such as waterproof transparent polyvinyl chloride (“PVC”) tubing or any similar material.

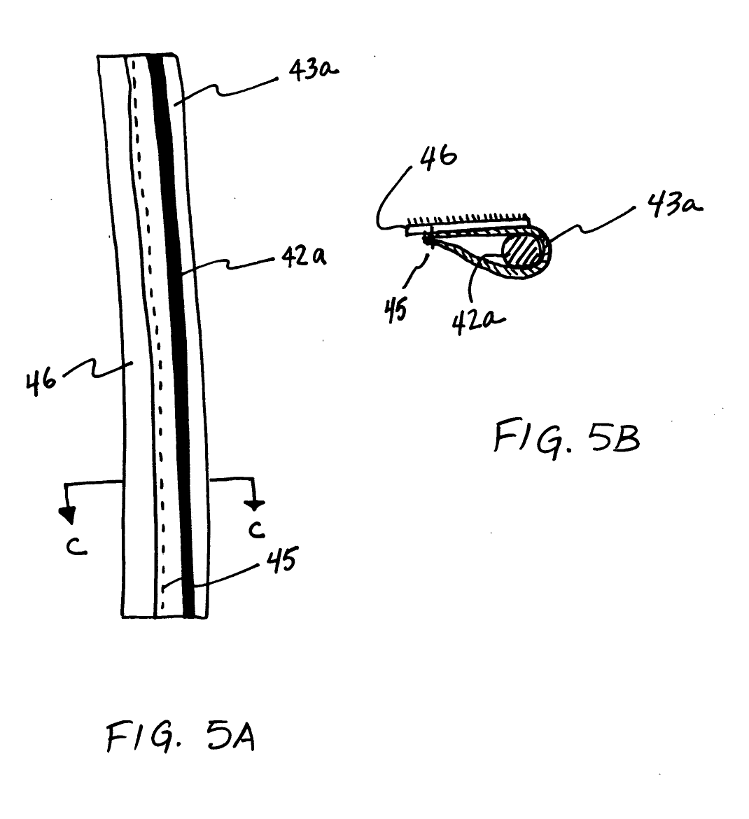

According to an embodiment of the present disclosure, as shown in FIGS. 5A and 5B, the protective covering 43a is placed around the light source 42a and is sewn/stitched on one end 45 to a detachment strip 46, which enables the light source 42a to be removable attached to the apparel. The detachment strip 46 may be a strip of Velco which mates with a matching strip of Velco attached to the apparel (not shown) so as to removably affix the light source 42a to the apparel. The detachment strip may be any another material which enables the removable attachment of the light source 42a to the apparel, such as for example, a zipper, or a piece of cloth with button holes which mate with buttons on the apparel, etc.

One or more power housings 40a, 40b may be located in one or more pockets of the garment along with one or more power sources 41a, 41b and one or more switches 44a, 44b contained therein. According to an alternative embodiment of the present disclosure, the one or more switches 44a, 44b and one or more power sources 41a, 41b may be mounted in the lining of a garment, stitched into the garment or attached with Velcro, for example, or any other fastening means well known to one of ordinary skill in the art. The one or more switches 44a, 44b and the one or more power sources 41a, 41b may be fused together. The one or more switches 44a, 44b provide a means for a wearer to turn the light sources 42a, 42b, 42c on/off or to a flashing mode. For example, switch 44a may control light source 42a on the front of the garment, whereas switch 44b may control light source 42b on the back of the garment. Moreover, the one or more power sources 41a, 41b can each control a light source 42. For example, one power source 41a can control light source 42a whereas the other power source 41b can control light source 42b.

The wires 72, 74 connecting the light source 42a to the power housing 40a, the wires 76, 78 connecting the light source 42b to the power housing 40b, and the wires 80, 82 connecting the light source 42c to the power housing 40b can all be disconnected and the each component of the lighted apparatus is removable so that a user can wash the garment without damaging the lighted apparatus. In addition, as discussed above in connection with footwear, the switches for the apparel may be coupled to the power sources through wireless communication means so as to turn the light sources on and off from a remote location.

According to an embodiment of the present disclosure, the light source 42a on the front of the garment may be a different color than the light source 42b on the back of the garment. Alternatively, the light sources on the same side of the garment can each be a different color. For example, light source 42b on the back of the garment can be a different color from light source 42c also on the back of the garment. Similarly, although a jacket 2 is depicted in FIGS. 4A and 4B, it is understood that the light sources 42a, 42b, 42c may be removably attached to any article of clothing, such as pants, for example, and that any number of light sources may be attached, and the may be controlled individually or collectively, as described above in connection with the shoe 1.

Numerous additional modifications and variations of the present invention are possible in view of the above-teachings.

What is claimed is:

1. A lighted apparatus for use in footwear including an upper portion and an opaque sole attached to the upper portion, comprising:
an exterior channel formed in the outer perimeter of the sole;
one or more light sources mounted in the exterior channel;
a protective covering surrounding the light source;
one or more switches coupled to the light source; and
a power source operatively coupled to the one or more switches and to the light source through one or more holes in the sole, wherein the power source is located in a cavity formed in the sole and the cavity is connected to the one or more holes.

2. The lighted apparatus of claim 1, wherein the one or more light sources are continuous tubes of electroluminescent wire.

3. The lighted apparatus of claim 1, wherein the one or more light sources are one or more different colors.

4. The lighted apparatus of claim 1, wherein a switch is located in the cavity formed in the sole and controls the operation of the one or more light sources.

5. The lighted apparatus of claim 1, wherein the one or more switches are toggle switches, push button switches or slide switches.

6. The lighted apparatus of claim 1, wherein a switch is located in the upper portion of the footwear and controls the operation of the one or more light sources.

7. The lighted apparatus of claim 4, further comprising a second switch located in the upper portion of the footwear which also controls the operation of the one or more light sources.

8. The lighted apparatus of claim 1, wherein the power source and the one or more switches are encased in a power housing that is secured to the cavity formed in the sole.

9. The lighted apparatus of claim 1, wherein the power housing is removably attached to the one or more light sources.

10. The lighted apparatus of claim 1, further comprising a removable insole placed on the top of the opaque sole located on the inside of the upper portion to conceal the cavity.

11. A lighted apparatus for use in apparel, comprising:
one or more continuous light sources removably attached to a garment in one or more areas;
a protective covering surrounding the light source;
one or more switches coupled to the light source; and
one or more power sources operatively coupled to the one or more switches and to the one or more light sources on the garment.

12. The lighted apparatus of claim 11, wherein the one or more light sources are continuous tubes of electroluminescent wire.

13. The lighted apparatus of claim 11, wherein the one or more light sources are one or more different colors.

14. The lighted apparatus of claim 11, wherein the one or light sources, one or more switches, or one or more power sources are removably attached to the garment in one or more areas with Velcro.

15. The lighted apparatus of claim 11, wherein the one or more switches are located in one or more pockets formed in the garment and control the operation of the light source.

16. The lighted apparatus of claim 11, wherein the one or more switches are toggle switches, push button switches or slide switches.

17. The lighted apparatus of claim 11, wherein the one or more power sources are each encased in a power housing.

18. The lighted apparatus of claim 11, wherein the apparel is a jacket.

19. The lighted apparatus of claim 11, wherein the apparel is pants.

20. A lighted apparatus for use in footwear including an upper portion and an opaque sole attached to the upper portion, comprising:
an exterior channel formed in the outer perimeter of the sole;
one or more light sources mounted in the exterior channel;
a protective covering surrounding the light source;
one or more switches disposed in an interior of the footwear and coupled to the light source;
a remote control detached from the footwear to activate and/or deactivate the one or more switches from a location remote from the footwear; and
a power source operatively coupled to the one or more switches and to the light source through one or more holes in the sole, wherein the power source is located in a cavity formed in the sole and the cavity is connected to the one or more holes.
